(19) United States
(12) Patent Application Publication
(10) Pub. No.: US 2026/0091717 A1
(43) Pub. Date: Apr. 2, 2026

(54) Utility Vehicle

(71) Applicant: Kubota Corporation, Osaka-shi (JP)

(72) Inventors: Masashi Inoue, Osaka (JP); Noriyasu Honjo, Osaka (JP)

(21) Appl. No.: 19/346,777

(22) Filed: Oct. 1, 2025

(30) Foreign Application Priority Data
Oct. 2, 2024 (JP) 2024-173090

(51) Int. Cl. B60N 2/90; B60N 2/01; B60N 3/06

(52) U.S. Cl. CPC B60N 2/91; B60N 2/01; B60N 3/06

(57) ABSTRACT

A utility vehicle includes a partition plate dividing the space between a front seat and a floor into a front space and a rear space. The partition plate includes a bottom portion integrally provided with a footrest for an occupant sitting on a rear seat.

### CROSS-REFERENCE TO RELATED APPLICATION

This application claims priority to Japanese Patent Application No. 2024-173090 filed October 2, 2024, the disclosure of which is hereby incorporated by reference in its entirety.

### BACKGROUND OF THE INVENTION

### Field of the Invention

The present invention relates to a utility vehicle.

### DESCRIPTION OF RELATED ART

Japanese Unexamined Patent Application Publication No. 2023-128775 discloses a utility vehicle including an occupant compartment (a cab unit) including a floor, a driver’s seat (a front seat), and a rear seat arranged right behind the driver’s seat in the front-rear direction of the utility vehicle.

In the related art, a linkage mechanism for causing a control lever to work in association with an operation target device is provided under the driver’s seat, and a cover for covering the linkage mechanism from the front and rear sides of the driver’s seat is provided. Because of this, there is limited space around the legs of an occupant sitting on the rear seat.

### SUMMARY OF THE INVENTION

The present invention provides a utility vehicle which provides a comfortable ride for a rear-seat occupant sitting on a rear seat while legroom for a driver’s seat is separated from legroom for the rear seat and which is also achievable at a low cost.

A utility vehicle according to the present invention includes: an occupant compartment including a floor, at least one front seat including a driver’s seat, and at least one rear seat including a first rear seat arranged behind the driver’s seat in a front-rear direction of a body of the utility vehicle; at least one partition plate including a first partition plate dividing a space between the driver’s seat and the floor into a front space and a rear space; and at least one footrest including a first footrest for an occupant sitting on the first rear seat, the first footrest being integrated with the first partition plate.

In this configuration, the front space connected to legroom for the driver’s seat is separated from the rear space connected to legroom for the first rear seat by the first partition plate, so that the legroom for the driver’s seat is separated from the legroom for the first rear seat by the first partition plate. An occupant sitting on the first rear seat can stretch out their legs in the rear space as a space under the driver’s seat and can also rest the legs on the first footrest. That is, the legroom for the driver’s seat is separated from the legroom for the first rear seat, and a rear-seat occupant sitting on the first rear seat can comfortably stay in the vehicle while stretching out and resting their legs on the first footrest. Besides, since the first footrest can be formed together with the first partition plate, it is possible to form the first footrest at a low cost while reducing effort necessary to form the first footrest, in comparison with a case where the first footrest is formed separately from the first partition plate.

The utility vehicle may be further configured such that the driver’s seat is be at a first end of the occupant compartment in a right-left direction of the body of the utility vehicle, the at least one front seat includes a second front seat located at a second end of the occupant compartment in the right-left direction and different from the driver’s seat, the at least one rear seat includes a second rear seat arranged behind the second front seat in the front-rear direction and different from the first rear seat, and a space between the second front seat and the floor is not partitioned off.

In this configuration, since legroom for the second front seat is connected to legroom for the second rear seat via a space under the second front seat, a long article can be loaded over the legroom for the second front seat and the legroom for the second rear seat through the space under the second front seat. This configuration allows a long article to be loaded into the vehicle, which is convenient.

The utility vehicle may be further configured such that the at least one front seat includes a third front seat between the driver’s seat and the second front seat, the at least one rear seat includes a third rear seat between the first rear seat and the second rear seat in such a manner that the third rear seat is arranged behind the third front seat in the front-rear direction, the at least one partition plate includes a second partition plate dividing a space between the third front seat and the floor into a front space and a rear space, and the at least one footrest includes a second footrest for an occupant sitting on the third rear seat, the second footrest being integrated with the second partition plate.

In this configuration, since the front space connected to legroom for the third front seat is separated from the rear space connected to legroom for the third rear seat by the second partition plate, the legroom for the third front seat is separated from the legroom for the third rear seat by the second partition plate. An occupant sitting on the third rear seat can stretch out their legs in the rear space as a space under the third front seat and can also rest the legs on the second footrest. That is, the legroom for the third front seat is separated from the legroom for the third rear seat, and the occupant sitting on the third rear seat can comfortably stay in the vehicle while stretching out and resting their legs on the footrest. Besides, since the second footrest can be formed together with the second partition plate, it is possible to form the second footrest at a low cost while reducing effort necessary to form the second footrest, in comparison with a case where the second footrest is formed separately from the second partition plate.

The utility vehicle may be further configured such that the second partition plate is integrated with the first partition plate.

In this configuration, since the second partition plate can be formed together with the first partition plate, it is possible to form the second partition plate at a low cost while reducing effort necessary to form the second partition plate, in comparison with a case where the second partition plate is formed separately from the first partition plate.

The utility vehicle may be further configured such that the floor includes an upwardly expanded portion extending in the front-rear direction under the third front seat and the third rear seat.

In this configuration, the upwardly expanded portion of the floor is located between the legroom for the driver’s seat and the legroom for the second front seat, so that the legroom for the driver’s seat is separated from the legroom for the second front seat. Besides, the upwardly expanded portion of the floor is located between the legroom for the first rear seat and the legroom for the second rear seat, so that the legroom for the first rear seat is separated from the legroom for the second rear seat. That is, by utilizing the upwardly expanded portion of the floor as partition means, it is possible to separate the legroom for the driver’s seat from the legroom for the second front seat and to separate the legroom for the first rear seat from the legroom for the second rear seat.

### BRIEF DESCRIPTION OF THE DRAWINGS

FIG. 1 is a side view of a whole utility vehicle viewed from the left side;

FIG. 2 is a plan view of an occupant compartment;

FIG. 3 is a sectional view taken along a line III-III in FIG. 2;

FIG. 4 is a sectional view taken along a line IV-IV in FIG. 2;

FIG. 5 is a sectional view taken along a line V-V in FIG. 2;

FIG. 6 is a sectional view taken along a line VI-VI in FIG. 2;

FIG. 7 is a sectional view taken along a line VII-VII in FIG. 2.

FIG. 8 is a perspective view from the upper left, illustrating the rear surfaces of a first partition plate and a second partition plate; and

FIG. 9 is a perspective view from the lower left, illustrating the front surfaces of the first partition plate and the second partition plate.

### DESCRIPTION OF THE INVENTION

Embodiments as examples of the present invention will be described below with reference to the drawings.

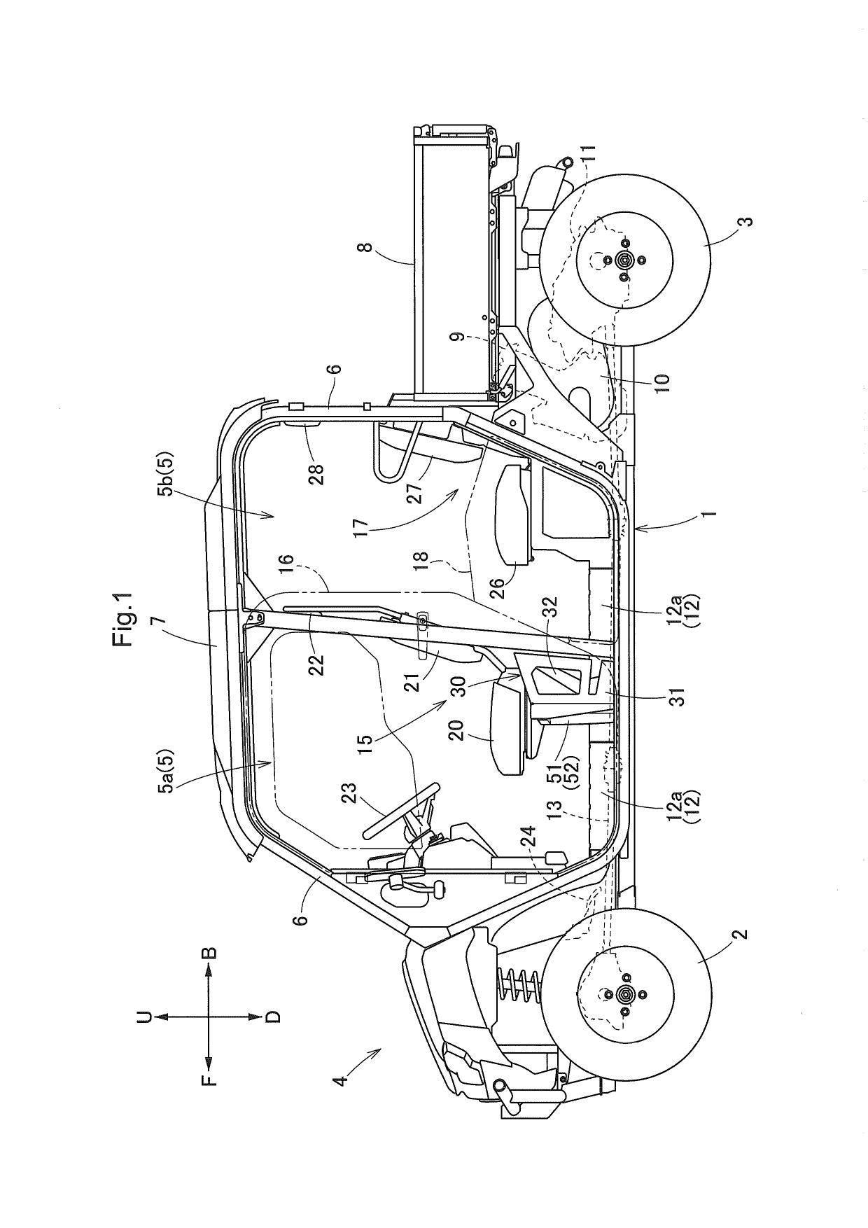

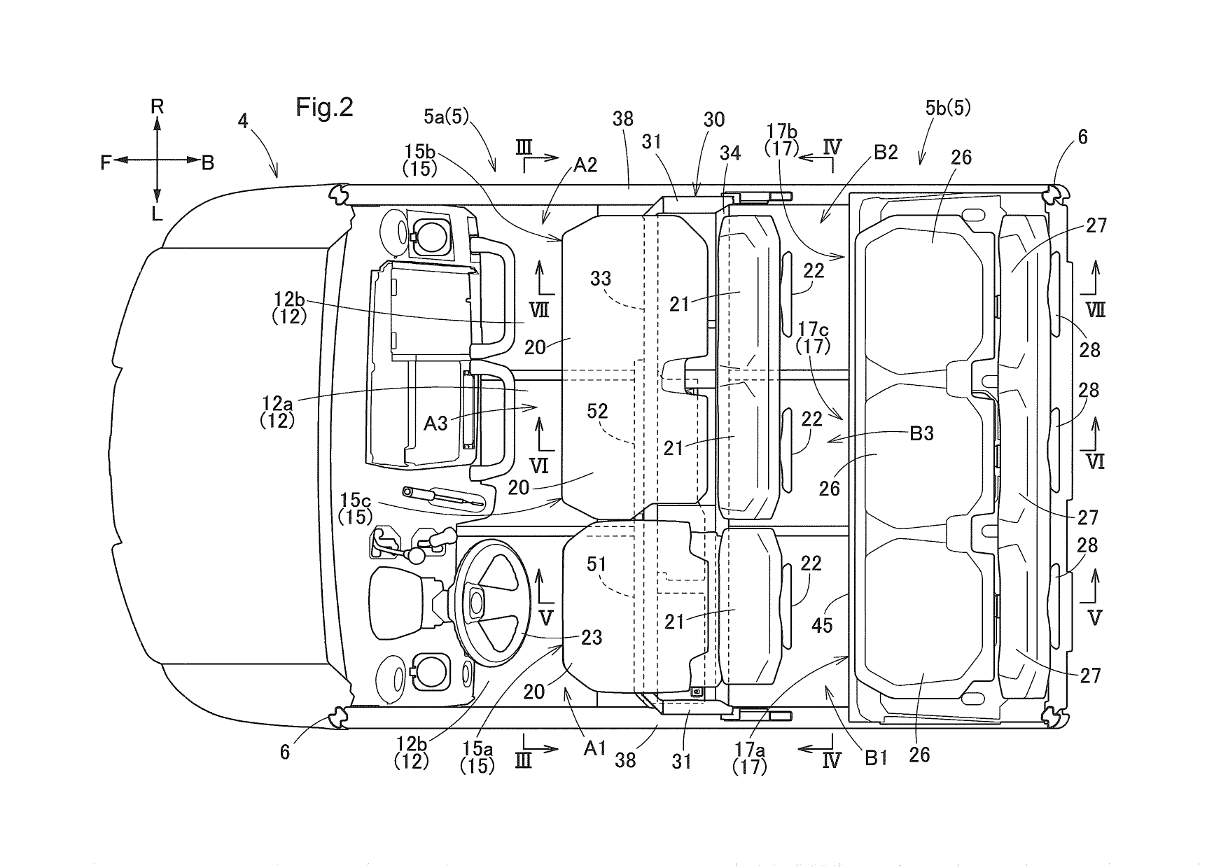

Note that, in the following description, in terms of the body of a utility vehicle, the direction of an arrow F illustrated in FIG. 1, 2 represents "vehicle’s forward direction," the direction of an arrow B illustrated in FIG. 1, 2 represents "vehicle’s rearward direction," the direction of an arrow U illustrated in FIG. 1, 3 represents "vehicle’s upward direction," the direction of an arrow D illustrated in FIG. 1, 3 represents "vehicle’s downward direction," the front side of the plane of paper of FIG. 1 and the direction of an arrow L in FIG. 2 represents "vehicle’s leftward direction," and the back side of the plane of paper of FIG. 1 and the direction of an arrow R in FIG. 2 represents "vehicle’s rightward direction." Vehicle’s right-left direction corresponds to vehicle’s width direction.

### [Overall Configuration of Utility Vehicle]

A utility vehicle illustrated in FIG. 1 is used for multipurpose applications such as article transportation or recreation. As illustrated in FIG. 1, the utility vehicle includes a body 4 including a body frame 1, a pair of right and left front wheels 2 that are steerable and drivable, and a pair of right and left rear wheels 3 that are drivable. An occupant compartment 5 is provided for a portion of the body 4 between the front wheels 2 and the rear wheels 3. The occupant compartment 5 includes a ROPS 6 covering cabin space, and a roof member 7 attached to an upper portion of the ROPS 6. A cargo box 8 is provided behind the occupant compartment 5. Below the cargo box 8, an engine 9, a continuously variable transmission 10 configured to receive an output from the engine 9 and continuously vary the output, and a travel transmission 11 configured to vary an output from the continuously variable transmission 10 and transmit the output to the front wheels 2 and the rear wheels 3 are provided. In the present embodiment, the continuously variable transmission 10 is a belt-type continuously variable transmission.

### [Configuration of occupant compartment}

As illustrated in FIGS. 1, 2, the occupant compartment 5 includes a front occupant compartment 5a, a rear occupant compartment 5b, and a floor 12 extending over the front occupant compartment 5a and the rear occupant compartment 5b.

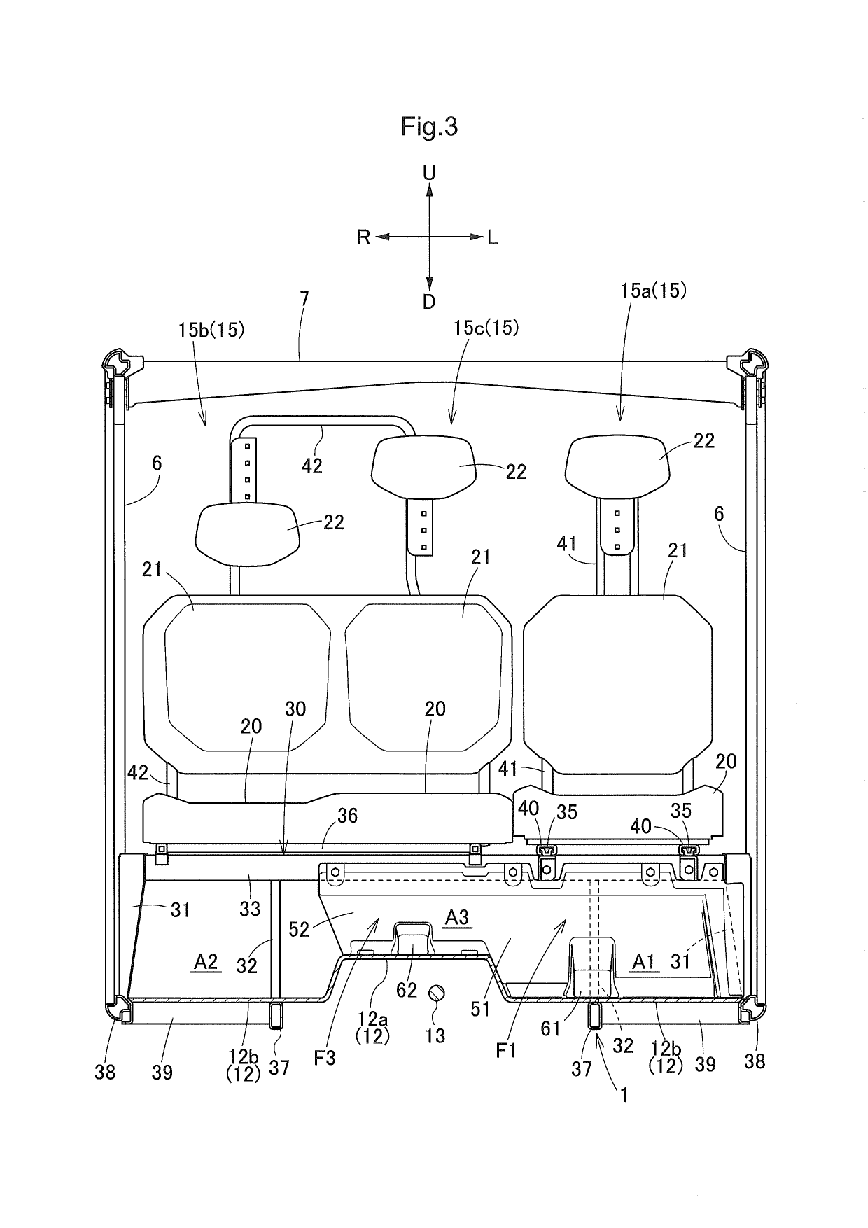

As illustrated in FIGS. 2, 3, an upwardly expanded floor portion 12a is formed in a central portion of the floor 12 in the vehicle’s width direction. The upper end of the upwardly expanded floor portion 12a is located higher than the upper ends of floor portions 12b on both sides of the upwardly expanded floor portion 12a in the floor 12. A transmission shaft 13 configured to transmit a front-wheel driving force from the travel transmission 11 to the front wheels 2 extends inside the upwardly expanded floor portion 12a.

As illustrated in FIG. 2, the front occupant compartment 5a includes front doorways located at both lateral ends of the front occupant compartment 5a, and three front seats 15 located between the front doorways at both lateral ends. The front doorways at both lateral ends are opened and closed by respective front doors 16 (see FIG. 1) that are openable and closable in a swinging manner.

As illustrated in FIG. 2, the rear occupant compartment 5b includes rear doorways located at both lateral ends of the rear occupant compartment 5b, and three rear seats 17 located between the rear doorways at both lateral ends. The rear doorways at both lateral ends are opened and closed by respective rear doors 18 (see FIG. 1) that are openable and closable in a swinging manner.

As illustrated in FIG. 2, the three front seats 15 are arranged in the vehicle’s width direction, that is, aligned side by side. Each of the three front seats 15 includes a seat base 20, a backrest 21, and a headrest 22. In the following description, a first front seat 15a represents a front seat 15 at one end of the front occupant compartment 5a in the vehicle’s right-left direction among the three front seats 15, a second front seat 15b represents a front seat 15 at the other end of the front occupant compartment 5a in the vehicle’s right-left direction among the three front seats 15, and a third front seat 15c represents a front seat 15 between the front seat 15 (the first front seat 15a) at the one end in the vehicle’s right-left direction and the front seat 15 (the second front seat 15b) at the other end in the vehicle’s right-left direction among the three front seats 15. In the present embodiment, the first front seat 15a is at the left end of the front occupant compartment 5a in the vehicle’s right-left direction, and the second front seat 15b is at the right end of the front occupant compartment 5a in the vehicle’s right-left direction.

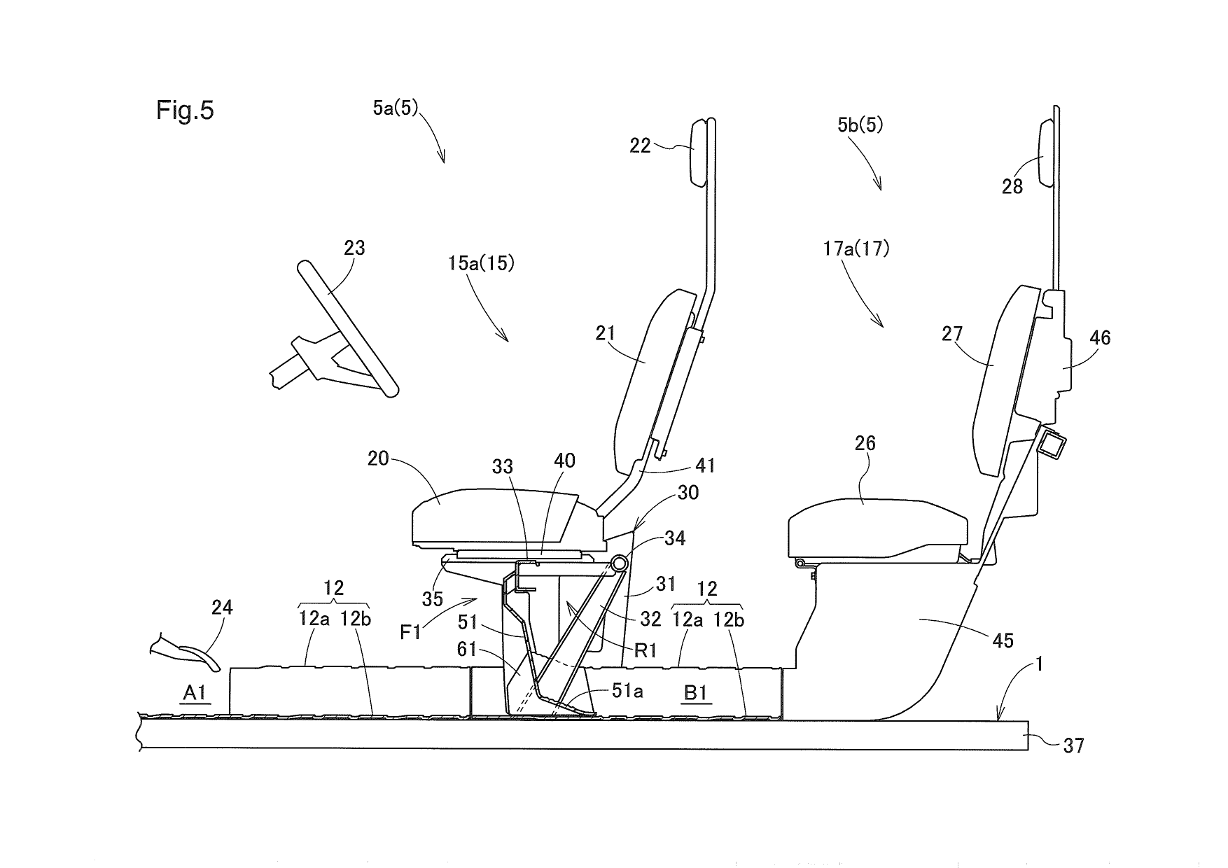

In the present embodiment, the seat base 20 of the second front seat 15b and the seat base 20 of the third front seat 15c are integrally coupled to each other but may be separated from each other. The backrest 21 of the second front seat 15b and the backrest 21 of the third front seat 15c are integrally coupled to each other but may be separated from each other. The first front seat 15a is manufactured separately from the second front seat 15b and the third front seat 15c and is independent from them. In the present embodiment, the first front seat 15a is a driver’s seat. A steering wheel 23 (see FIGS. 2 and 5) configured to steer the front wheels 2 is mounted forward of the first front seat 15a, and a brake pedal 24 (see FIGS. 2 and 5) and so on are mounted below and forward of the first front seat 15a.

As illustrated in FIGS. 3, 5, the first front seat 15a, the second front seat 15b, and the third front seat 15c are attached to an upper portion of a front-seat support frame 30 installed in a standing state on the body frame 1 and supported by the body frame 1 via the front-seat support frame 30.

More specifically, as illustrated in FIGS. 3, 4, 6, 7, the front-seat support frame 30 includes a pair of right and left vertical plate-shaped side columns 31, a pair of right and left center columns 32 located between the right and left side columns 31, a front transverse rod 33 coupled to upper portions of the right and left side columns 31 and extending in the vehicle’s width direction, and a rear transverse rod 34 disposed behind the front transverse rod 33, coupled to the upper portions of the right and left side columns 31 and upper portions of the right and left center columns 32, and extending in the vehicle’s width direction. At a left end portion of the front-seat support frame 30, a pair of right and left driver-seat guide rails 35 extending in the front-rear direction are supported by the front transverse rod 33 and the rear transverse rod 34. A front-seat support member 36 is disposed to the right of the right and left driver-seat guide rails 35 and supported by the front transverse rod 33 and the rear transverse rod 34. The front-seat support member 36 includes right and left longitudinally oriented rods, and a transverse rod coupling front end portions of the right and left longitudinally oriented rods to each other.

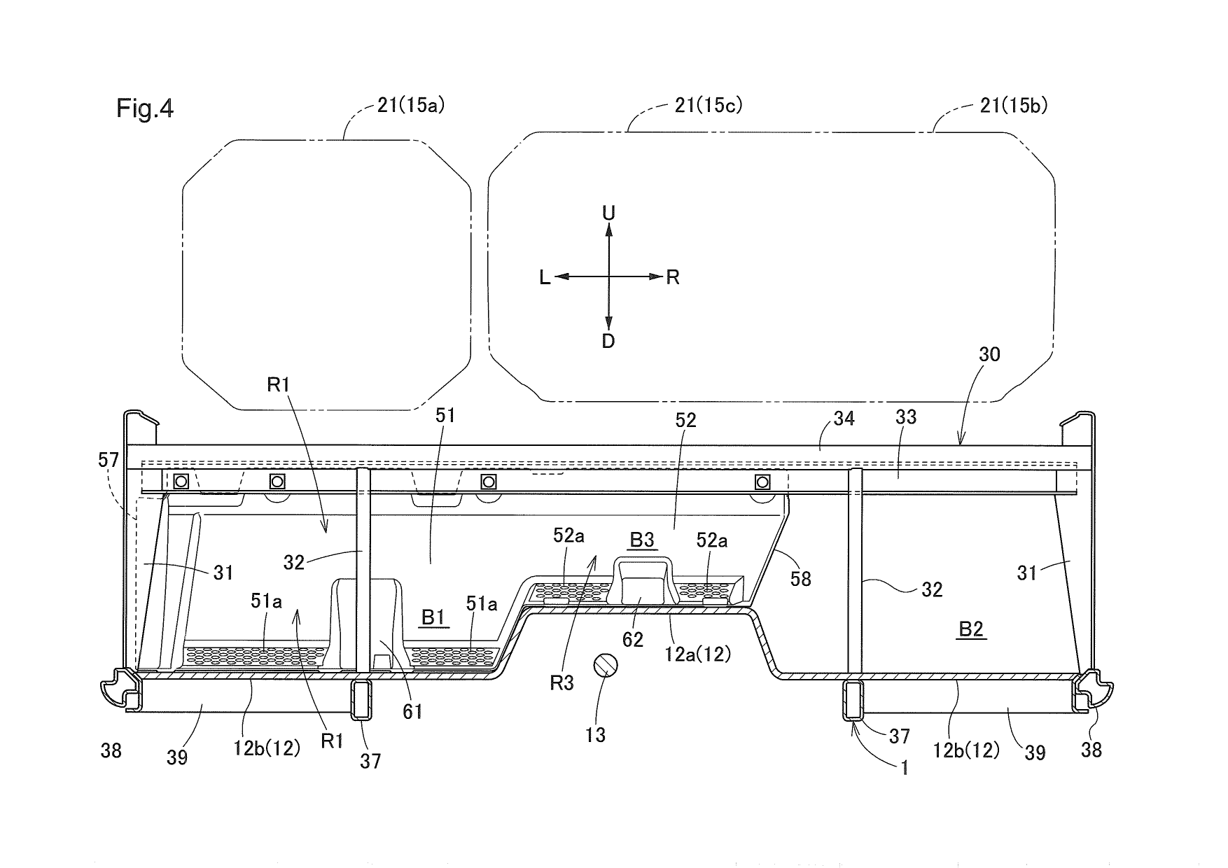

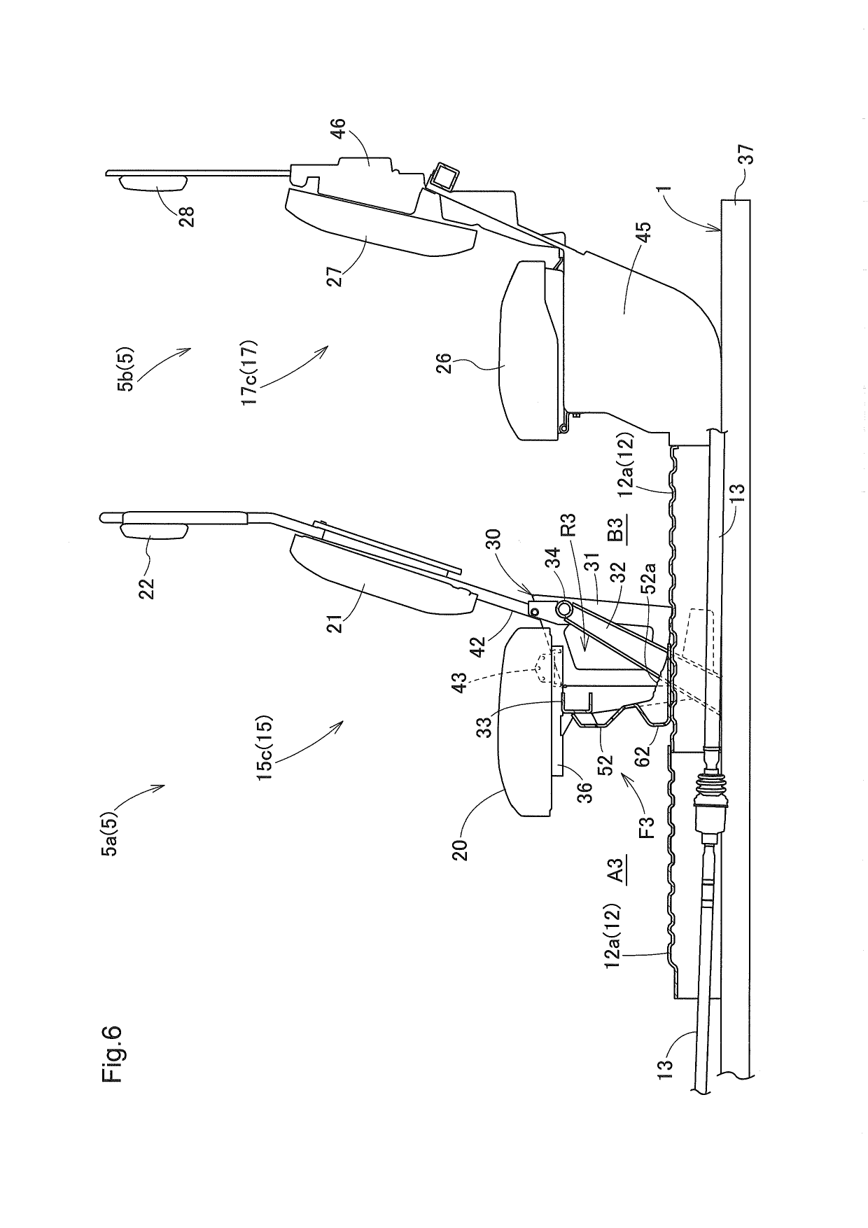

As illustrated in FIGS. 3, 4, the right and left center columns 32 are installed in a standing state on right and left center frames 37 extending in the front-rear direction and constituting the body frame 1. As illustrated in FIGS. 5, 6, the right and left center columns 32 are installed at an angle in such a manner as to be inclined rearward toward their upper ends. The right and left side columns 31 are installed in a standing state on right and left side frames 38 extending in the front-rear direction and constituting the body frame 1. The right and left side frames 38 are coupled to distal end portions of coupling frames 39 extending laterally outwardly from the center frames 37 in the vehicle’s right-left direction and supported by the center frames 37 via the coupling frames 39.

As illustrated in FIGS. 3, 5, the right and left driver-seat guide rails 35 support seat base supports 40 provided for the seat base 20 of the first front seat 15a in such a manner that the seat base supports 40 are slidably adjustable in the front-rear direction. The backrest 21 and the headrest 22 of the first front seat 15a are supported by support frames 41 extending upward from the seat base supports 40 and supported by the seat base supports 40 via the support frames 41.

In the first front seat 15a as a driver’s seat, the seat base 20 is adjusted by sliding over the driver-seat guide rails 35 to move the backrest 21 and the headrest 22 in the front-rear direction together with the seat base 20, so that the attachment position of the seat base 20, the backrest 21, and the headrest 22 to the front-seat support frame 30 can be adjusted in the front-rear direction.

As illustrated in FIGS. 3, 6, and 7, the front-seat support member 36 supports the seat base 20 of the second front seat 15b and the seat base 20 of the third front seat 15c, which are mounted and fixed on the front-seat support member 36. The backrest 21 and the headrest 22 of the second front seat 15b and the backrest 21 and the headrest 22 of the third front seat 15c are attached to support frames 42 extending upward from the rear transverse rod 34 and supported by the front-seat support frame 30 via the support frames 42.

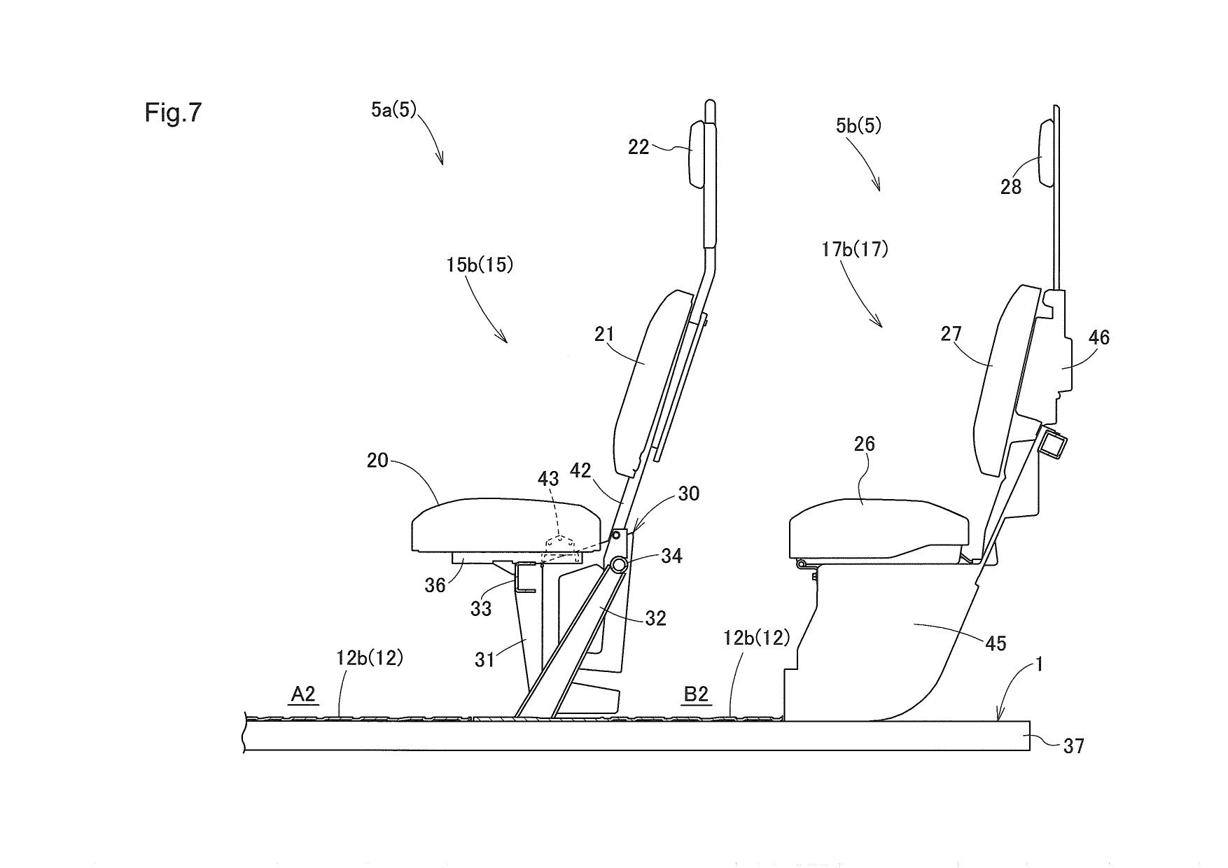

A support member 43 (see FIGS. 6 and 7) pivotally supporting a rear portion of the front-seat support member 36 is coupled to the front transverse rod 33 and the rear transverse rod 34, so that the front-seat support member 36 is supported by the front transverse rod 33 and the rear transverse rod 34 in such a manner to be swingable in the up-down direction around a pivot shaft located in the rear portion of the front-seat support member 36 as a swing pivot point. The seat base 20 of the second front seat 15b and the seat base 20 of the third front seat 15c swing in the up-down direction to be opened and closed in association with swinging of the front-seat support member 36 in the up-down direction, so that the front-seat support frame 30 is opened and closed.

As illustrated in FIG. 2, the three rear seats 17 are arranged in the vehicle’s width direction, that is, aligned side by side. Each of the three rear seats 17 includes a seat base 26, a backrest 27, and a headrest 28. In the present embodiment, respective seat bases 26 of the three rear seats 17 are integrally coupled to each other but may be separated from each other. Respective backrests 27 of the three rear seats 17 are integrally coupled to each other but may be separated from each other.

As illustrated in FIGS. 5, 6, 7, respective seat bases 26 of the three rear seats 17 are attached to a rear-seat support base 45 installed in a standing state on the body frame 1. Respective backrests 27 and respective headrests 28 of the three rear seats 17 are attached to a support frame 46 extending from the body frame 1 behind the rear-seat support base 45. The three rear seats 17 are supported on the body frame 1 via the rear-seat support base 45 and the support frame 46.

In the following description, a first rear seat 17a represents a rear seat 17 at one end of the rear occupant compartment 5b in the vehicle’s right-left direction among the three rear seats 17, a second rear seat 17b represents a rear seat 17 at the other end of the rear occupant compartment 5b in the vehicle’s right-left direction among the three rear seats 17, and a third rear seat 17c represents a rear seat 17 between the rear seat 17 (the first rear seat 17a) at the one end in the vehicle’s right-left direction and the rear seat 17 (the second rear seat 17b) at the other end in the vehicle’s right-left direction among the three rear seats 17. In the present embodiment, the first rear seat 17a is at the left end of the rear occupant compartment 5b in the vehicle’s right-left direction, and the second rear seat 17b is at the right end of the rear occupant compartment 5b in the vehicle’s right-left direction.

As illustrated in FIG. 2, the first front seat 15a and the first rear seat 17a are arranged front to back, with the first rear seat 17a being right behind the first front seat 15a. The second front seat 15b and the second rear seat 17b are arranged front to back, with the second rear seat 17b being right behind the second front seat 15b. The third front seat 15c and the third rear seat 17c are arranged front to back, with the third rear seat 17c being right behind the third front seat 15c.

As illustrated in FIGS. 2, 3, the upwardly expanded floor portion 12a of the floor 12 extends in the front-rear direction under the third front seat 15c and the third rear seat 17c. As illustrated in FIGS. 2, 3, a legroom A1 for the first front seat 15a as the driver’s seat is separated from a legroom A2 for the second front seat 15b by the upwardly expanded floor portion 12a. As illustrated in FIG. 4, a legroom B1 for the first rear seat 17a is separated from a legroom B2 for the second rear seat 17b by the upwardly expanded floor portion 12a.

As illustrated in FIGS. 3, 5, a first partition plate 51 is disposed under the first front seat 15a. A space between the first front seat 15a and the floor 12 is divided by the first partition plate 51 into a front space F1 and a rear space R1. The front space F1 connected to the legroom A1 for the first front seat 15a as the driver’s seat and the rear space R1 connected to the legroom B1 for the first rear seat 17a are separated from each other by the first partition plate 51, so that the legroom A1 for the first front seat 15a and the legroom B1 for the first rear seat 17a are separated from each other by the first partition plate 51.

As illustrated in FIGS. 4, 5, and 8, right and left first footrests 51a for an occupant sitting on the first rear seat 17a are integrally formed on a rear surface of a bottom portion of the first partition plate 51. The right and left first footrests 51a are inclined upward at the toe.

The occupant sitting on the first rear seat 17a can stretch out their legs in the rear space R1 as a space under the first front seat 15a and rest the legs on the first footrests 51a. Due to the use of the first footrests 51a, a rear-seat occupant sitting on the first rear seat 17a determines a position where their legs are placed, thereby making it possible to easily avoid the shin or the like of the rear-seat occupant from making contact with the rear transverse rod 34.

As illustrated in FIGS. 3, 6, a second partition plate 52 is disposed under the third front seat 15c. A space between the third front seat 15c and the floor 12 is divided by the second partition plate 52 into a front space F3 and a rear space R3. The front space F3 connected to a legroom A3 for the third front seat 15c and the rear space R3 connected to a legroom B3 for the third rear seat 17c are separated from each other by the second partition plate 52, so that the legroom A3 for the third front seat 15c is separated from the legroom B3 for the third rear seat 17c by the second partition plate 52.

As illustrated in FIGS. 4, 6, and 8, right and left second footrests 52a for an occupant sitting on the third rear seat 17c are integrally formed on a rear surface of a bottom portion of the second partition plate 52. The right and left second footrests 52a are inclined upward at the toe.

The occupant sitting on the third rear seat 17c can stretch out their legs in the rear space R3 as a space under the third front seat 15c and rest the legs on the second footrests 52a. Due to the use of the second footrests 52a, a rear-seat occupant sitting on the third rear seat 17c determines a position where their legs are placed, thereby making it possible to easily avoid the shin or the like of the rear-seat occupant from making contact with the rear transverse rod 34.

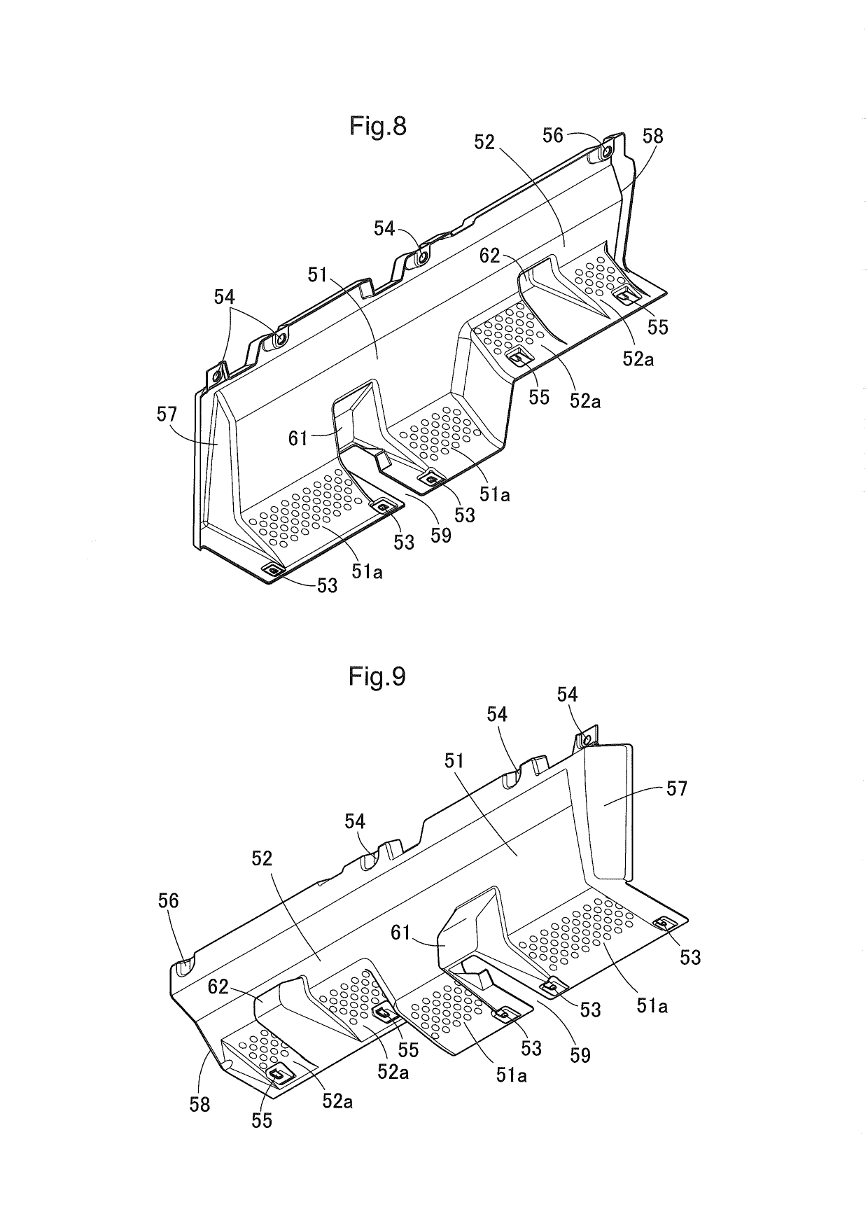

The bottom portion of the first partition plate 51 is coupled to the floor 12 by coupling bolt fastened in lower mounting holes 53 (see FIG. 8) located at end portions of the first footrests 51a, and the upper portion of the first partition plate 51 is coupled to the front transverse rod 33 of the front-seat support frame 30 by coupling bolts fastened in upper mounting holes 54 (see FIG. 8). The first partition plate 51 is fixed to the floor 12 and the front-seat support frame 30 by the coupling bolts.

The bottom portion of the second partition plate 52 is coupled to the floor 12 by coupling bolts fastened in lower mounting holes 55 (see FIG. 8) located at end portions of the second footrests 52a, and the upper portion of the second partition plate 52 is coupled to the front transverse rod 33 of the front-seat support frame 30 by a coupling bolt fastened in an upper mounting hole 56 (see FIG. 8). The second partition plate 52 is fixed to the floor 12 and the front-seat support frame 30 by the coupling bolts.

As illustrated in FIGS. 8, 9, the second partition plate 52 is integrated with the first partition plate 51. A vertical plate portion 57 for reinforcement is formed at an end portion of the first partition plate 51 which end portion is opposite from the second partition plate 52. A vertical plate portion 58 for reinforcement is formed to an end portion of the second partition plate 52 which end portion is opposite from the first partition plate 51. A cutout hole 59 through which the center column 32 of the front-seat support frame 30 passes is formed between the right and left first footrests 51a. A first leg section 61 projecting forward from a portion between the right and left first footrests 51a of the first partition plate 51 is mounted on the top surface of the floor 12 to support the first partition plate 51. A second leg section 62 projecting forward from a portion between the right and left second footrests 52a of the second partition plate 52 is mounted on the top surface of the floor 12 to support the second partition plate 52. The first leg section 61 is projected due to the bulging of the first partition plate 51. The second leg section 62 is projected due to the bulging of the second partition plate 52. In the present embodiment, the first partition plate 51 and the second partition plate 52 are made of resin.

As illustrated in FIGS. 3, 4, and 7, a space between the second front seat 15b and the floor 12 is not partitioned off. The legroom A2 for the second front seat 15b is connected to the legroom B2 for the second rear seat 17b via a space under the second front seat 15b, so that a long article can be loaded over the legroom A2 for the second front seat 15b and the legroom B2 for the second rear seat 17b via the space under the second front seat 15b.

### [Alternative Embodiments]

(1) The above embodiment deals with an example in which the first front seat 15a and the first rear seat 17a are at the left end of the occupant compartment in the vehicle’s right-left direction. However, they may be at the right end of the occupant compartment in the vehicle’s right-left direction.

(2) The above embodiment deals with an example in which the space between the second front seat 15b and the floor 12 is not partitioned off. However, the space may be partitioned off.

(3) The above embodiment deals with an example in which the second partition plate 52 is integrated with the first partition plate 51. However, the second partition plate 52 may be formed separately from the first partition plate 51.

(4) The above embodiment deals with an example in which the second front seat 15b, the third front seat 15c, the second rear seat 17b, and the third rear seat 17c are provided. However, a configuration in which the second front seat 15b, the third front seat 15c, the second rear seat 17b, and the third rear seat 17c are not provided, a configuration in which the second front seat 15b and the second rear seat 17b are provided without the third front seat 15c and the third rear seat 17c, or a configuration in which the third front seat 15c and the third rear seat 17c are provided without the second front seat 15b and the second rear seat 17b may be also employed.

(5) The above embodiment deals with an example in which the upwardly expanded floor portion 12a is provided, but the upwardly expanded floor portion 12a may not be provided.

(6) In the above embodiment, no partition plate is provided under the second front seat 15b, and no footrest for the occupant of the second rear seat is provided. However, a partition plate may be provided under the second front seat 15b, and a footrest for the occupant of the second rear seat may be provided.

### Industrial Applicability

The present invention is applicable to a utility vehicle including an occupant compartment including a floor, a driver’s seat, and a rear seat arranged right behind the driver’s seat in the front-rear direction.

### Description of the Reference Numerals

5 occupant compartment

12 floor

12a upwardly expanded floor portion (floor portion)

15a first front seat (driver’s seat)

15b second front seat

15c third front seat

17a first rear seat (rear seat)

17b second rear seat

17c third rear seat

51 first partition plate (partition plate)

51a first footrest (footrest)

52 second partition plate

52a second footrest

What is claimed is:

1. A utility vehicle, comprising:
an occupant compartment comprising a floor, at least one front seat comprising a driver’s seat, and at least one rear seat comprising a first rear seat arranged behind the driver’s seat in a front-rear direction of a body of the utility vehicle;
at least one partition plate comprising a first partition plate dividing a space between the driver’s seat and the floor into a front space and a rear space; and
at least one footrest comprising a first footrest for an occupant sitting on the first rear seat, and the first footrest is integrated with the first partition plate.

2. The utility vehicle according to claim 1, wherein:
the driver’s seat is at a first end of the occupant compartment in a right-left direction of the body of the utility vehicle,
the at least one front seat comprises a second front seat located at a second end of the occupant compartment in the right-left direction and different from the driver’s seat,
the at least one rear seat comprises a second rear seat arranged behind the second front seat in the front-rear direction and different from the first rear seat, and
a space between the second front seat and the floor is not partitioned off.

3. The utility vehicle according to claim 2, wherein:
the at least one front seat comprises a third front seat between the driver’s seat and the second front seat,
the at least one rear seat comprises a third rear seat between the first rear seat and the second rear seat in such a manner that the third rear seat is arranged behind the third front seat in the front-rear direction,
the at least one partition plate comprises a second partition plate dividing a space between the third front seat and the floor into a front space and a rear space, and
the at least one footrest comprises a second footrest for an occupant sitting on the third rear seat, and the second footrest is integrated with the second partition plate.

4. The utility vehicle according to claim 3, wherein:
the second partition plate is integrated with the first partition plate.

5. The utility vehicle according to claim 3, wherein:
the floor comprises an upwardly expanded portion extending in the front-rear direction under the third front seat and the third rear seat.
